(19) United States
(12) Patent Application Publication
(10) Pub. No.: US 2013/0128556 A1
(43) Pub. Date: May 23, 2013

(54) PET HARNESS HAVING MULTIPLE LED STRIPS

(71) Applicants: Gregory Brauser, Ft. Lauderdale, FL (US); Brandon Bal, Ft. Lauderdale, FL (US)

(72) Inventors: Gregory Brauser, Ft. Lauderdale, FL (US); Brandon Bal, Ft. Lauderdale, FL (US)

(21) Appl. No.: 13/585,935

(22) Filed: Aug. 15, 2012

Related U.S. Application Data
(63) Continuation-in-part of application No. 13/299,973, filed on Nov. 18, 2011.
Application No. 13/299,973 is a continuation-in-part of application No. 29/429,377, filed on Aug. 10, 2012.

(51) Int. Cl. F21V 21/00

(52) U.S. Cl. 362/108

(57) ABSTRACT

A light-emitting pet comfort harness having a harness body, a neck loop, and a body strap. The harness body includes at least one light-emitting diode (LED) strip comprising a first strip portion and a second strip portion wherein the first strip is substantially perpendicular to the second portion. The first strip is disposed through the neck loop of the harness and the second is disposed along the length of the harness body. The harness is comprised of a fabric material and the LED strip is disposed between two layers of the fabric. The harness may also be comprised of a printable fabric. The LED strip is coupled to a switch assembly which is attached to the neck loop of the device. The switch assembly provides a plurality of operating modes for LEDs. The LED strip is not visible through the fabric although the light emitted from the LEDs is visible.

### CROSS REFERENCE TO RELATED APPLICATIONS

This application is a continuation in part of U.S. patent application Ser. No. 13/299,973 filed on Nov. 18, 2011 and U.S. Design patent application 29/429,377 filed Aug. 10, 2012.

### STATEMENT REGARDING FEDERALLY SPONSORED RESEARCH OR DEVELOPMENT

N/A

### BACKGROUND OF THE INVENTION

1. Field of the Invention

The present invention generally relates to wearable LED devices and more particularly to a pet harness having a plurality flexible LED lighting elements or strip embedded therein.

2. Description of Related Art

A light-emitting diode (hereafter “LED”) is a semi-conductor light source that provides discrete light when powered by an electric source. Traditional LEDs emitted low-intensity red light, however more modern versions are capable of emitting light across the entire visible light spectrum at varying levels of intensity. LEDs are useful for a variety applications but are particularly useful for safety and decorative wearable products, including belts, bracelets, pet collars, pet harnesses and pet leashes. Much of the prior art in this field has been limited to providing LEDs within clear plastic tubing that, while providing the desired safety lighting, leaves much to be desired aesthetically. Further, the prior art does not provide for activating buttons that are less prone to inadvertent activation, or that provide a master on/off switch, which is particularly useful when the device is being worn by a child or pet.

For example, U.S. Pat. Nos. 5,879,076 and 6,146,006 to Cross describe an apparatus for the transmission of light adapted in a belt or vest article having a light source that transmits light along a self-support elongated light transmitting member. The light source and light transmitting members are embedding in a casement having a light-colored backing and a translucent front material. The device is activated by a simple on/off switch located proximal to the light source. The required light transmitting members greatly increase the overall weight of the device and increase the number of parts required, tooling costs, and manufacturing costs while limiting the flexibility and usability of the wearable device. Additionally, the on/off switch is prone to inadvertent activation.

U.S. Pat. No. 6,970,090 to Sciarra describes a pet tracking collar comprising clear flexible tubing containing a plurality of LEDs and an antenna and a radio transmitter. The collar provides only safety lighting and radio transmission features and does not provide for a particularly elegant and aesthetically pleasure configuration.

U.S. Pat. No. 7,140,327 to Morehead provides a pet collar having an illumination source and one or more fiber optic cables coupled to the illumination source in order to provide for transmission of the light. The device is activated by an on/off button near the illumination source, which must be exposed from the casement in order to be activated. While providing safety lighting, the fiber optic cables are expensive, difficult to install, and have a high failure rate. Additionally, the invention does not provide for a useful and aesthetically pleasing casement.

Accordingly, while there are certain wearable LED devices present available, none provide an enhanced casement that can include a variety of printable patterns and designs while still maintaining a high level of light transmission. Further, the prior art fails to disclose a suitable on/off button or switch design that prevents inadvertent activation of the LEDs while being compact, discrete, and visually appealing. Further still, there has yet to be an LED pet harness that provides optimal comfort for pets but also provides the aesthetic and safety enhancements of embedded LED lighting.

It is, therefore, to the effective resolution of the aforementioned problems and shortcomings of the prior art that the present invention is directed. However, in view of the LED and similar light-emitting devices in existence at the time of the present invention, it was not obvious to those persons of ordinary skill in the pertinent art as to how the identified needs could be fulfilled in an advantageous manner.

### SUMMARY OF THE INVENTION

The present invention provides various embodiments of a flexible light transmitting device, generally comprising a comfort harness having a harness body, a neck loop, and a body strap. The harness body includes at least one light-emitting diode (LED) strip which strip comprises a first strip portion and a second strip portion wherein the first strip is substantially perpendicular to the second portion. In some embodiments the first strip is disposed through the neck loop of the harness and the second is disposed along the length of the harness body. In some embodiments, the harness is comprised of a fabric such as a mesh material and the LED strip is disposed between two layers of the fabric harness. In some embodiments, the fabric of the harness includes at least one printable layer and one backing layer wherein the printable layer is translucent to permit transmission of light from the light-emitting diodes through the printable layer when the light-emitting diodes are activated; however, the printable layer is such that the circuitry and components of the LED strip are not visible therethrough. In some embodiments, the printable layer is a polyester material adapted to receive printed indicia by way of thermal printing process. The backing layer is substantially opaque and may comprise a durable nylon webbing or polypropylene material.

The embedded LED strip comprises an elongated flexible casing containing the spaced apart light-emitting diodes, one or more light interrupting spacers disposed between the light-emitting diodes, and at least one ribbon wire extending through the casing and electrically coupling said light-emitting diodes. Further, the light-emitting diodes are electrically coupled to a switch assembly which comprises a battery, a master switch, and a toggle button. The switch assembly is attached to the neck loop of the harness and provides the LED switch with a plurality of operative modes including an on mode, and off mode, and a flashing mode. In some embodiments, the toggle button is used to toggle between the various operating modes, but the toggle button is only active when the master switch is in the “on” position. This prevents inadvertent activation of the light-emitting diodes.

Accordingly, it is an object of the present invention to provide an enhanced LED comfort harness for pets that includes a hidden or stealth LED strip between mesh layers of the harness wherein the strip provide LED lights throughout the harness including across its width and along its length.

It is another object of the present invention to provide an enhanced LED comfort harness for pets that includes a hidden or stealth LED strip underneath a printable layer of the harness which layer can include a variety of printed patterns, colors, and indicia.

It is another object of the present invention to provide an enhanced LED device that is operable between a plurality of operating modes, including off, on, flashing, and breathing.

It is yet another object of the present invention to provide an LED device that includes a switch assembly that prevents inadvertent activation of the light-emitting diodes.

It is yet another object of the present invention to provide an LED device that is integrated, attractive, and aesthetically pleasing while providing relatively high intensity light transmission for decorative and safety purposes.

In accordance with these and other objects which will become apparent hereinafter, the instant invention will now be described with particular reference to the accompanying drawings.

### BRIEF DESCRIPTION OF THE DRAWINGS

FIG. 1 is a perspective view of one embodiment of the present invention, configured as a pet harness.

FIG. 2 is an exploded view of one aspect of an embodiment of the present invention.

FIG. 3 is a cutaway view of one embodiment of the present invention.

FIG. 4 is a top view of one embodiment of the LED strip used in the present invention.

FIG. 5 is a perspective view of one embodiment of the switch assembly used in the present invention.

FIG. 6 is a top view of one embodiment of the LED strip of the present invention, depicting a first strip portion perpendicular to a second strip portion.

FIG. 7 is a cutaway perspective view of one embodiment of the present invention, depicting the LED strip disposed within the comfort harness.

### DETAILED DESCRIPTION

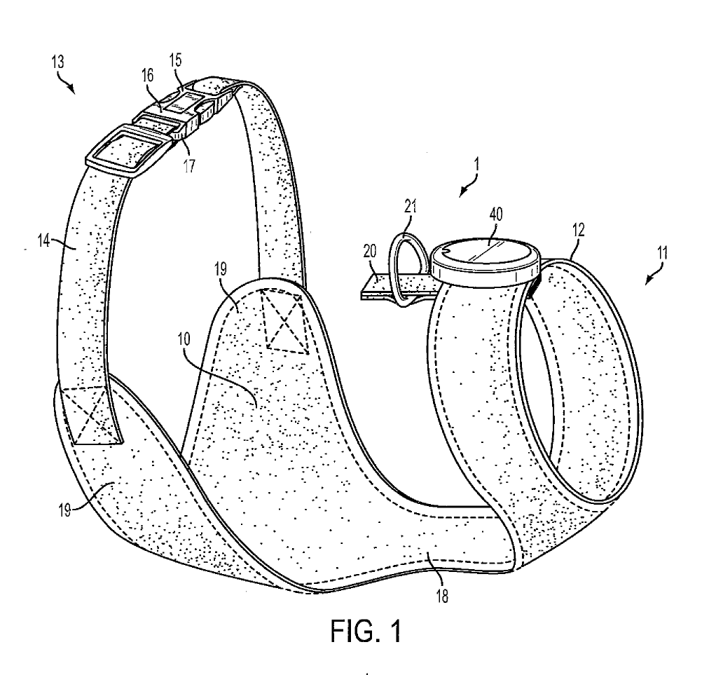

With reference to FIG. 1, shown is one embodiment of the LED device 1 of the present invention, configured as a pet harness, more particularly a comfort harness. Device 1 comprises a harness body 10 that includes a first end 11 having a neck loop 12 which is configured to be received over the head of a pet and ends up disposed around the neck thereof. The device 10 further includes a second end 13 having a body strap 14 which is received around the chest or torso of a pet. The strap 14 includes a distal snap assembly 15 which includes a male snap member 16 and a female snap member 17 which allows for the harness to be removeably received on a pet. The harness body 10 includes a central portion 18 which is disposed on the underside of the pet and extends from the neck loop 12 rearward, ending at the strap 14. The harness body 10 further includes two side protrusions or wing-shaped members 19 which provide padding and support for the comfort of the pet as well as providing attachment points for the strap 14.

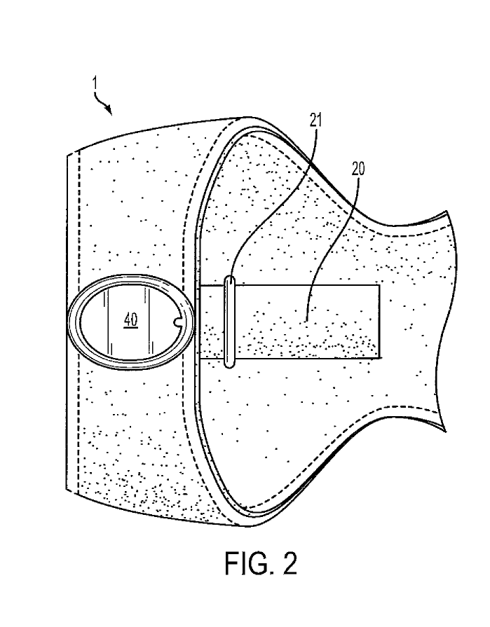

FIG. 2 is an expanded view of one embodiment of the device 1 of the present invention. Shown is a top portion of the neck loop 12 which includes a switch assembly 40 and a pull tab 20. The pull tab 20 includes a loop or ring 21 which is configured to receive a leash or tie off. In some embodiments, a leash having a clip or clasp can removeably engage the ring 21 for added security. It is appreciated that the location of the switch assembly 40 on device 1 should not be considered limiting as there are other locations that may be equally suitable. However, having the switch assembly 40 located at the top portion of neck loop 12 provides easier access thereto for the user, especially when connecting a leash or tie off.

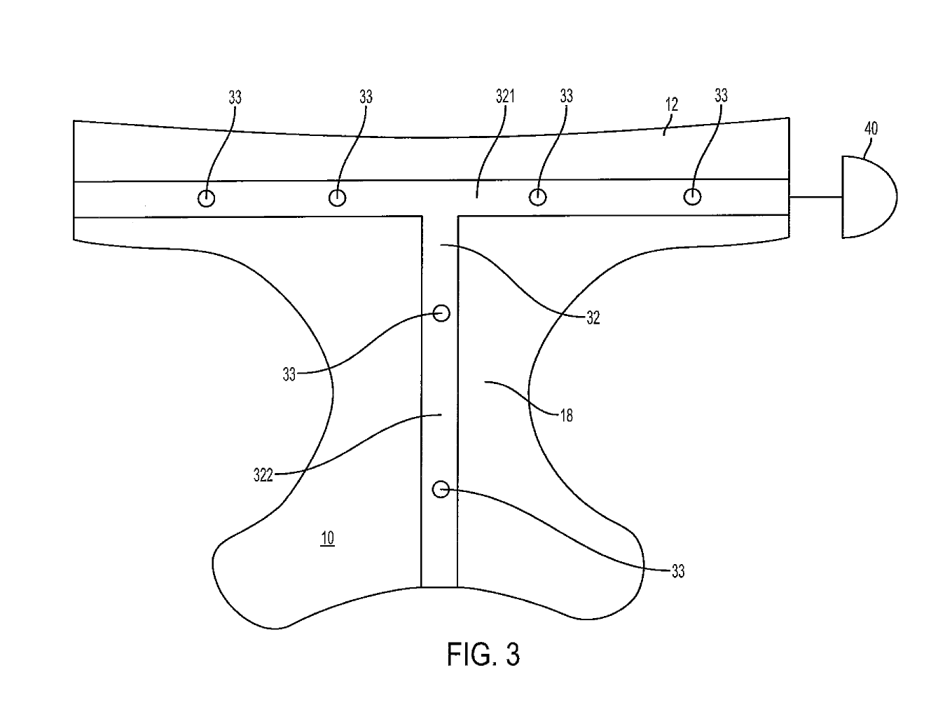

FIG. 3 is a cutaway view of one embodiment of the device 1 of the present invention. As shown, on the inside of harness body 10 are disposed one or more embedded LED strips 32. In some configurations, the LED strip 32 comprises a cross-shaped to T-shaped LED strip which provides a cross strip 321 and a vertical strip 322, with the two strips substantially perpendicular to one another. Accordingly, the cross strip 321 passes substantially through the neck loop 12 of the harness body 10 and the vertical strip 322 passed substantially through the central portion 18 of the harness body 10. It is appreciated that the LED strip 32 is disposed between one or more layers of fabric of the harness body 10 as described in further detail below. One end of the LED strip 32 is connected to switch assembly 40 which, as shown in FIGS. 1-2 is attached externally and is accessible from the outside of the harness body 10.

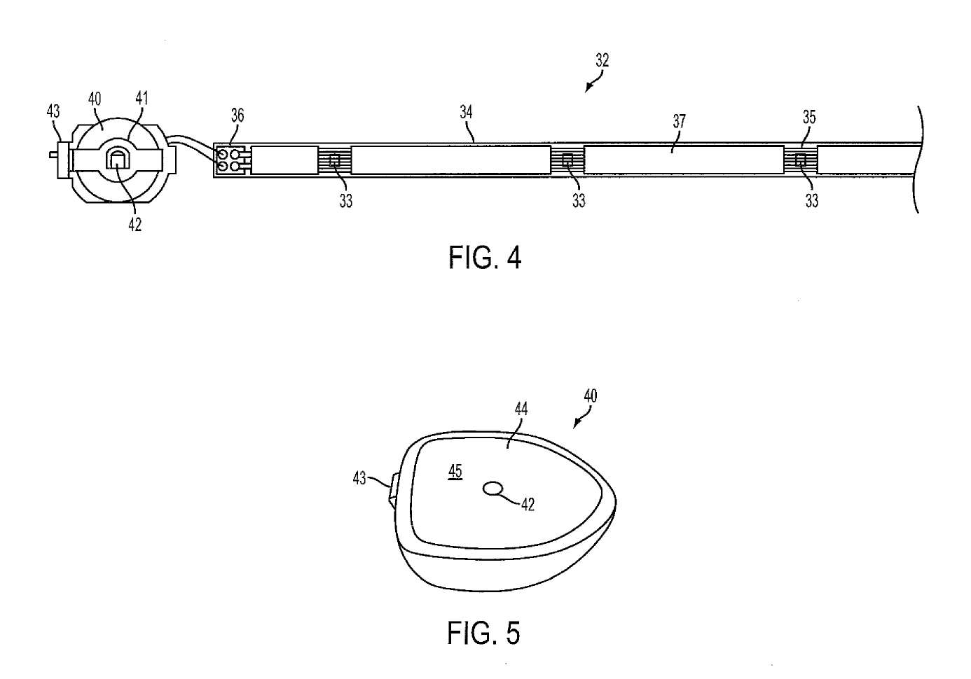

FIG. 4 depicts a portion of LED strip 32 in more detail. As shown, strip 32 comprises a plurality of LEDs 33 spaced apart and disposed within an elongated flexible casing 34. Disposed between each of the LEDs 33 and also contained within casing 34 are elongated light-interrupting spacers 37. In some embodiments, the spacers 37 comprise two layers. A plurality of ribbon wires 35 are disposed along the length of the strip 32 and electrically couple the LEDs 33. In some embodiments, the ribbon wires 35 are disposed between the two layers of the spacers, except that at least a portion of the wires 35 are exposed proximal to the LEDs 33. Accordingly, spacers 37 provide a conduit through which wires 35 pass, while also serving to limit light transmission therethrough so that light emitted by LEDs 33 does not “bleed” along the length of the LED strip 32, which would otherwise reduce the intensity of the LEDs 33 proximal to their location.

The ribbon wires 35 also connect the series of LEDs 33 to a connector 36. Connector 36 is in turn electrically coupled to switch assembly 40 (which is the same structure as switch assembly 16 and 27 discussed above), which is proximal to connector 36. In FIG. 4, switch assembly 40 is shown in cutaway, in order to better visualize the internal components thereof. Accordingly, in some embodiments, switch assembly 40 comprises a printed circuit board 41, a toggle button 42, and a master switch 43. FIG. 5 shows switch assembly 40 in its assembled state, having a housing 44 with master switch 43 disposed on a side thereof, and toggle button 42 disposed on a top surface thereof. A covering label 45 may be placed over toggle button 42, whereby the label 45 is flexible to maintain the toggling action of toggle button 42 and provides a surface for indicia such as logos or patterns.

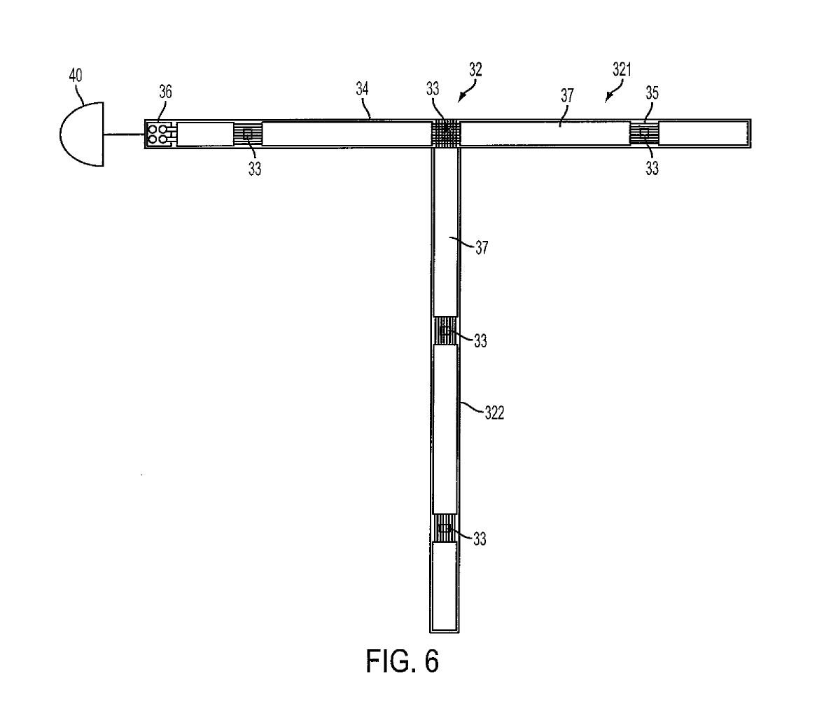

With reference to FIG. 6 shown is another embodiment of LED strip 32 in a cross-shaped or t-shaped configuration as intended for installation inside the harness body 10 of the present invention. In this configuration, the cross strip 321 and the vertical strip 322 are integral however in other embodiments, the cross strip 321 and vertical strip 322 could be discrete components in electrical communication. In the integrated embodiment, the ribbon wires 35 interconnect all of LEDs 33. Switch assembly 40 is disposed at one end of the strip 32 circuit and provides operability therefore as described above.

Referring back to FIG. 5, switch assembly 40 is manipulated by the user to activate the LEDs 33 on-demand. Circuit board 41 contains a chipset and the necessary electrical contacts for the various components of the present invention. Both master switch 43 and toggle button 42 are electrically coupled to printed circuit board 41, which is electrically coupled to connector 36. Circuit board 41 is configured to receive power from battery 48, and can open and close the electrical contacts in order to send power to the various components. In some embodiments, switch assembly 40 is configured such that master switch 43 has at least two positions, a master-on position and a master-off position. In the master-off position, the switch assembly is completely off, the LEDs 33 are deactivated, and toggle button 42 is “killed” such that it cannot activate LEDs 33. In some case, in the master-off position, the connection between battery 48 and circuit board 41 is temporarily severed, in order to avoid inadvertent activation of LEDs 33. In the master-on position, power can now be transferred from battery 48 to the various components and toggle button 42 is now active and can be depressed to activate LEDs 33.

The logic contained within the chipset of circuit board 41 is such that toggle button 42 can be depressed by a user in sequence to operatively select a plurality of operating modes, including “off,” “on,” and “flashing.” For example, beginning in the “off” mode, depressing toggle button 42 once will enter the “on” mode and power will be sent from battery 48, through circuit board 41 to connector 36, along wires 35 and to LEDs 33. Depressing toggle button 42 again will enter the “flashing” mode, whereby the logic within circuit board 41 intermittently sends power from battery 48 along to connector 36, along wires 35 and to LEDs 33 such that LEDs 33 “flash” in intermittent fashion. Depressing toggle button 42 once again will return the device to the “off” position. Additional modes may be contemplated, such as a pulsating or “breathing” mode and/or faster or slower “flashing” intervals. These modes and their specific timing and functionality are dictated by the logic embedded in circuit board 41. Of course, the sequence of the various modes is also dictated by the logic embedded in circuit board 41 and can vary without departing from the scope of the present invention.

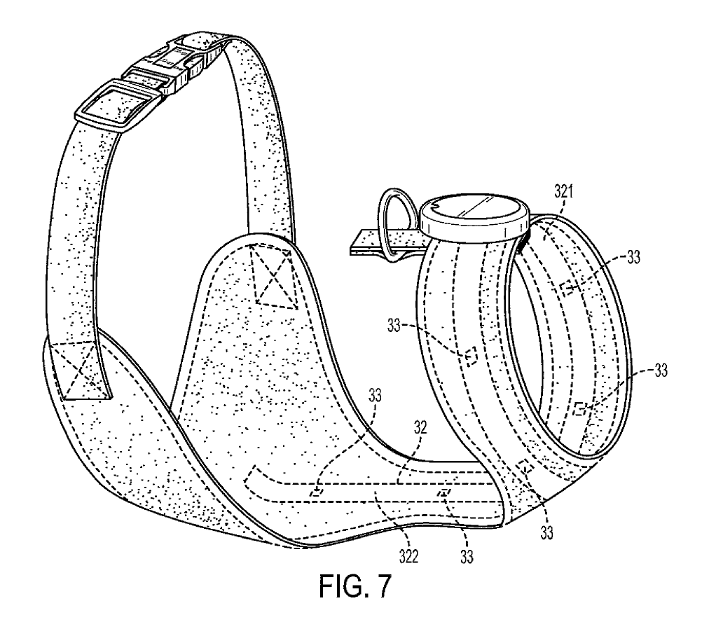

With reference back to FIG. 3 and to FIG. 7, the LED strip 32 is disposed between the fabric layers of the harness body 10 in such a manner that when activated the one or more LEDs 33 are visible through the fabric. In some embodiments, the fabric comprises a dual-ply flexible mesh material although other materials are equally suitable. In some embodiments, one or the harness body 10 comprises a translucent printable layer and a backing layer. In some embodiments, the backing layer comprises a substantially opaque nylon or polypropylene plain weave webbing material having suitable strength and deformity resistance as is typical of belts, collars, and leashes. In some embodiments, the printable layer comprises a weatherproof plain weave polyester material that is adapted to receive printable indicia by way of a thermal printing process. More specifically, a polyvinyl chlorate (PVC), Polyethylene terephthalate (PET), or other like thermoplastic polymer film containing a pattern, logos, pictures, words, or other indicia in various colors is provided over the printable layer and heat is applied thereto, which transfers the indicia from the film onto the printable layer. Further, the polyester material of the printable layer is such that the layer is at least partially translucent.

In some embodiments, regardless of the material selected, the fabric layers of the harness body 10 may be sewn or hot-melted together in order to secure LED strip 32 therebetween. Other means of securing the fabric layers to one another may be equally suitable. Furthermore, it is appreciated that the harness body 10 comprises material or fabric that is weatherproof in order to prevent water from seeping into and damaging the LED strip 32.

The fabric of the harness body 10 is configured to provide optimum lighting response from the LEDs 33 of strip 32. In some embodiments, the fabric is relatively opaque such that the structural components of the LED strip 32 are not visible therethrough. However, the fabric should be translucent enough to allow a substantial portion of the light emitted from LEDs 33 to pass through and be visible to the human eye.

By way of example, in some embodiments, the harness body 10 may include at least one printable layer comprising a 100% plain weave polyester material specified as 1′ webbing, 150D, 10 g/yard and approximately 1.0 mm thick. A ¾″ polyester webbing may also be provided as printable layer 31, specified as 150 D, 7.5 g/yard, and approximately 1.0 mm thick. In some embodiments, the backing layer may comprise a 100% plain weave polypropylene material at 1″ specified as 900D, 16 g/yard, 1.5 mm thick or at ¾″ specified as 900D, 12 g/yard, 1.5 mm thick. These specifications are not limiting as other sizes and specifications may be selected depending on the desired light transmission properties of the constituent fabric layers of the harness body 10. Further, other suitable materials may be utilized provided they are suitably weatherproof such as various nylons, polyesters, cottons, cotton blends, and the like. In the case where a printable layer is not desired, the harness body 10 may comprises two layers of the same fabric material for a unified look and feel.

It is appreciated that the LED device of the present invention can be configured in a variety of manners, including as wearable apparel items and other useful products. The present disclosed presents the LED device configured as a wearable pet collar and complimentary pet leash. However, the device could be configured as or integrated into belts, vests, bracelets, necklaces, lanyard key chains, or other items wherein an elongated, flexible body is desired and/or useful. Accordingly, the present invention is not limited to the embodiments discussed herein and shown the figures and other embodiments are well within the scope of the present invention.

Accordingly, the instant invention has been shown and described herein in what is considered to be the most practical and preferred embodiments. It is recognized, however, that departures may be made therefrom within the scope of the invention and that obvious modifications will occur to a person skilled in the art.

What is claimed is:

1. A pet comfort harness, comprising
a harness body, a neck loop, and a light-emitting diode strip;
said strip disposed between two or more fabric layers of said harness;
said strip comprising a first strip portion and a second strip portion, each portion including a plurality of spaced apart light-emitting diodes;
wherein said first portion is disposed along said neck loop and said second portion is disposed along said harness body, said first portion disposed substantially perpendicular with respect to said second portion;
wherein said fabric layers are translucent to permit transmission of light from said light-emitting diodes through said fabric layers.

2. The harness of claim 1, said light-emitting diode strip further comprises an elongated flexible easing containing said light-emitting diodes, one or more light interrupting spacers disposed between said light-emitting diodes, and at least one ribbon wire extending through said casing and electrically coupling said light-emitting diodes.

3. The harness of claim 2, wherein said light-emitting diodes are further electrically coupled to a switch assembly.

4. The harness of claim 3, wherein said switch assembly is disposed on said neck loop.

5. The harness of claim 3, wherein said switch assembly comprises a battery, a master switch, and a toggle button, said toggle button adapted to activate said light-emitting diodes by way of said battery.

6. The harness of claim 5, wherein said toggle button activates said light-emitting diodes only when said master switch is in an on position.

7. The harness of claim 1, wherein said light-emitting diodes are configured to provide a plurality of operating modes, including an off mode, an on mode, and a flashing mode.

8. The harness of claim 1, wherein said light-emitting diode strip is not visible through said fabric layers.

9. The harness of claim 1, further including a body strap attached to said harness body and configured to be disposed around the torso of a pet.

10. The harness of claim 1, wherein said fabric layers comprise a printable layer and a backing layer.

11. The harness of claim 10, wherein said printable layer receives printed indicia by thermal printing.

12. The harness of claim 10, wherein said printable layer comprises a polyester material.

13. The harness of claim 10, wherein said backing layer is substantially opaque.

14. The harness of claim 10, wherein said backing layer comprises nylon.

15. The harness of claim 10, wherein said backing layer comprises polypropylene.

16. The harness of claim 1, wherein said harness is weatherproof.
